(19) United States
(12) Patent Application Publication
(10) Pub. No.: US 2010/0131244 A1
(43) Pub. Date: May 27, 2010

(54) FINITE ELEMENT ANALYSIS METHOD, FINITE ELEMENT ANALYSIS APPARATUS, AND COMPUTER PROGRAM

(75) Inventors: Hidekazu Murakawa, Osaka (JP); Hisashi Serizawa, Osaka (JP)

Correspondence Address: DARBY & DARBY P.C., P.O. BOX 770, Church Street Station, New York, NY, 10008-0770, US

(73) Assignee: OSAKA UNIVERSITY, Osaka (JP)

(21) Appl. No.: 11/720,825

(22) PCT Filed: Sep. 7, 2005
(86) PCT No.: PCT/JP05/16447

§ 371 Date: Jul. 2, 2007

(30) Foreign Application Priority Data
Dec. 3, 2004 (JP) 2004-351788

(51) Int. Cl. G06F 17/10; G06F 17/50

(52) U.S. Cl. 703/1; 703/2

(57) ABSTRACT

A finite element analysis method, finite element analysis device, and computer program through which the computation load is reduced and the computation time is shortened to a minimum value without increasing the computation time exponentially even if the shape of a structure is complex. Each finite element is divided into regions. The displacement value and the stress value are computed for each region, and a maximum value of the differences in stress value between the regions. When the computed maximum value is larger than a predetermined value, each of the regions is divided into regions. For each region, iterative computation is carried out to compute a maximum value of the differences in stress value between the regions. If the number of divisions does not reach a predetermined limit value, each region is further divided into regions, and a maximum value of the differences in stress value between the regions is computed iteratively for each region. If the number of divisions reaches the predetermined limit value, information representing that the maximum value of the differences in stress value is larger than a predetermined value is sent to the outside.

### CROSS-REFERENCE TO PRIOR APPLICATIONS

This is a U.S. national phase application under 35 U.S.C. §371 of International Patent Application No. PCT/JP2005/016447, filed Sep. 7, 2005, which claims the benefit of Japanese Application No. 2004-351788, filed Dec. 3, 2004, both of which are incorporated by reference herein. The International Application was published in Japanese on Jun. 8, 2006 as International Publication No. WO 2006/059417 A1 under PCT Article 21(2).

### TECHNICAL FIELD

The present invention relates to a finite element analysis method, a finite element analysis apparatus, and computer program for reducing computation load and shortening computation time by specifying fineness of mesh dividing finite elements according to computed stress gradient when analyzing a structure using a finite element method, compared to a case of computing to analyze an entire structure with fine mesh.

### BACKGROUND ART

As a computer technology progresses, it has practically been possible to analyze problems such as a nonlinear problem and a transient problem of a complex structure. In other words, when the shape of a structure to be analyzed becomes complex, it is required to perform a nonlinear analysis. For the nonlinear analysis on such a structure, a solution is often obtained in use of the Finite Element Method (hereinafter, referred to as FEM).

When the shape of a structure becomes complex, stress may occur in various portions of the structure. Accordingly, higher-dimensional simultaneous equations need to be solved. When the shape becomes more complex, the computation load in a computation processing device tends to become greater and time required to obtain the solution tends to increase exponentially. Conventionally, a preferable mesh division and an appropriate computation time are determined as balancing the fineness of mesh for dividing the structure and computation time for obtaining the solution. However, considerable skill is required to specify the fineness of dividing mesh.

A stress distribution of the structure can be obtained by converting partial differential equations of stressed locations into simultaneous equations for each of the divided finite elements and solving the converted simultaneous equations.

[Patent Document 1] none

### DISCLOSURE OF THE INVENTION

However, when the above structure is analyzed by the nonlinear analysis, a lot of processing time is required to compute nonlinear analyzes even when a current high-speed calculating process of a computer is used. Further, there has been a problem that it is difficult to determine whether or not the fineness of mesh for dividing the structure and computation time for obtaining a solution are most appropriate before a calculating process even by a person having considerable skill although it can be judged after the solution is obtained.

It is expected that opportunities for analyzing structures having more complex shape will increase. Generally, when an entire structure is divided into finite elements and nonlinear analysis is performed for all the finite elements, an order N (N is a natural number) of simultaneous equations to be solved increases and the computation time is proportional to N³. Therefore, due to the increase in the order of simultaneous equations with more complexity in structures' shapes, there has been a concern that huge amount of time is required for the computations.

The present invention has been made in view of the above problems and has an object to provide a finite element analysis method, a finite element analysis apparatus, and computer program capable of reducing computation load while minimizing computation time without increasing computation time exponentially even when a shape of a structure is complex.

In order to achieve the above object, a finite element analysis method according to a first aspect is a finite element analysis method for implementing analysis of stress under a predetermined external force for each of a plurality of finite elements obtained by dividing a region occupied by a structure, the method comprising the steps of: dividing each of the finite elements into a plurality of regions, setting a counter showing the number of divisions to a default value, calculating a displacement value and a stress value for each of the divided regions, calculating a largest value of stress value differences among the regions, and determining whether or not the calculated largest value is greater than a predetermined value; when it is determined that the largest value is greater than the predetermined value, dividing the plurality of regions into a further plurality of regions, setting the counter to a value obtained by counting up the number of divisions, and calculating a largest value of stress value differences among the divided regions by repeatedly calculating for each of the regions; determining whether or not the value of the counter reaches a predetermined limit value; when the value of the counter does not reach the limit value, dividing the further divided regions into a further plurality of regions, setting the counter to a value obtained by counting up the number of divisions, and calculating a largest value of stress value differences among the divided regions by repeatedly calculating for each of the regions; and when it is determined that the value of the counter reaches the limit value, outputting information indicating that the largest value of the stress value differences is greater than the predetermine value.

A finite element analysis method according to a second aspect is based on the first aspect, and characterized by further comprising the step of receiving the limit value.

A finite element analysis method according to a third aspect is based on the first aspect or the second aspect, and characterized by further comprising the steps of: correcting the displacement value and the stress value so that displacement and stress continuously change at borders of the plurality of divided regions; and calculating a largest value of stress value differences among the regions based on the corrected stress value.

A finite element analysis apparatus according to a fourth aspect is a finite element analysis apparatus for implementing analysis of stress under a predetermined external force for each of a plurality of finite elements obtained by dividing a region occupied by a structure, the apparatus comprising: means for dividing each of the finite elements into a plurality of regions; a counter for showing the number of divisions; means for setting the counter to a default value; means for calculating a displacement value and a stress value for each of the divided regions; means for calculating a largest value of stress value differences among the regions; means for determining whether or not the calculated largest value is greater than a predetermined value; means for dividing the plurality of regions into a further plurality of regions when it is determined that the largest value is greater than the predetermined value; means for setting the counter to a value obtained by counting up the number of divisions; means for calculating a largest value of stress value differences among the divided regions by repeatedly calculating for the each of the regions; means for determining whether or not the value of the counter reaches a predetermined limit value; means for dividing into a still further plurality of regions when it is determined that the value of the counter does not reach the limit value; means for calculating a largest value of stress value differences among the divided regions by repeatedly calculating for each of the regions; and means for outputting information indicating that the largest value of the stress value difference is greater than the predetermined value when it is determined that the value of the counter reaches the limit value.

A finite element analysis apparatus according to a fifth aspect is based on the fourth aspect, and characterized by further comprising means for receiving the limit value.

A finite element analysis apparatus according to a sixth aspect is based on the fourth aspect or the fifth aspect, and characterized further comprising: means for correcting the displacement value and the stress value so that displacement and stress continuously change at borders of the plurality of divided regions; and means for calculating a largest value of stress value differences among the regions based on the corrected stress value.

A computer program according to a seventh aspect is a computer program capable of being executed with a computer for implementing analysis of stress under a predetermined external force for each of a plurality of finite elements obtained by dividing a region occupied by a structure, the program for causing the computer to execute: a step of dividing each of the finite elements into a plurality of regions; a step of setting a counter showing the number of divisions to a default value; a step of calculating a displacement value and a stress value for each of the divided regions; a step of calculating a largest value of stress value differences among the regions; a step of determining whether or not the calculated largest value is greater than a predetermined value; a step of dividing the plurality of regions into a further plurality of regions when it is determined that the largest value is greater than the predetermined value; a step of setting the counter to a value obtained by counting up the number of divisions; a step of calculating a largest value of stress value differences among the divided regions by repeatedly calculating for each of the regions; a step of determining whether or not the value of the counter reaches a predetermined limit value; a step of dividing the further divided regions into a further plurality of regions when it is determined that the value of the counter does not reach the limit value; a step of setting the counter to a value obtained by counting up the number of divisions; a step of calculating a largest value of stress value differences among the divided regions by repeatedly calculating for each of the regions; and a step of outputting information indicating that the largest value of the stress value differences is greater than the predetermined value when it is determined that the value of the counter reaches the limit value.

A computer program according to a eighth aspect is based on the seventh aspect, and characterized in that the program causes the computer to further execute a step of receiving the limit value.

A computer program according to a ninth aspect is based on the seventh aspect or the eight aspect, and characterized in that the program causes the computer to further execute: a step of correcting the displacement value and the stress value so that displacement and stress continuously change at borders of the plurality of divided regions; and a step of calculating a largest value of stress value differences among the regions based on the corrected stress value.

In the first, fourth and seventh aspects, the procedures of dividing each of the finite elements obtained by mesh division of a region occupied by the structure into a plurality of regions, calculating a largest value of differences in stress values among the divided regions, that is, a stress gradient, dividing into a further plurality of regions when the calculated stress gradient is greater than the predetermined value, and calculating the stress gradient again for the divided regions are repeated for layering. When the stress gradient becomes equal to or smaller than the predetermined value before the number of layering reaches the predetermined limit value, since low-dimensional simultaneous equations are solved for each layer, the computation time is simply proportional to the total number of the divided regions included in all the layers. As a result, the computation time does not increase exponentially.

Accordingly, even when the shape of the structure becomes complex and the order of simultaneous equation converted from partial differential equation increases, the computation time merely increases in proportion to the total number of regions obtained by dividing the finite elements into layers of finer mesh. Thus, the stress distribution can be obtained in a shorter period of time without reducing the accuracy of the calculation.

Further, when the stress gradient does not get equal to or smaller than the predetermined value before the number of layering reaches the predetermined limit value, information indicating the condition is sent to the outside so that the user can easily find, for example, an unconformity in the mesh or an occurrence of crack.

In the second, fifth, and eighth aspects, since the number of layering, that is, a limit value of the counter, which is a limit value of the number of dividing the finite elements to reduce the stress gradient to be equal to or smaller than the predetermined value, is received, extra computation process regarding the complex shape of the structure is not required and a stress distribution can be obtained in shorter period of time.

In the third, sixth and ninth aspects, the displacement value and the stress value are corrected so that the displacement and stress change continuously at borders of a plurality of regions obtained by dividing finite elements into layers, and a stress gradient is calculated based on the corrected stress value. Accordingly, it is possible to secure not only the continuity of stress value at a vertex of the divided region, in which displacements can be specified, but also the continuities of displacement and stress at borders of divided regions without using complicated computing process.

According to the first, fourth, and seventh aspects, even when the shape of the structure becomes complex and the order of simultaneous equations converted from partial differential equations increases, the computation time merely increases in proportion to the total number of regions obtained by dividing the finite elements into layers of finer mesh. Accordingly, a stress distribution can be obtained in a shorter period of time without reducing the accuracy of the calculation.

Further, when the stress gradient does not get equal to or smaller than the predetermined value before the number of layering reaches the predetermined limit value, information indicating the condition is sent to outside so that the user can easily find, for example, an unconformity in the mesh or an occurrence of crack.

According to the second, fifth, and eighth aspects, since the number of layering, that is, a limit value of the counter, which is a limit value of the number of dividing the finite elements to reduce the stress gradient to be equal to or smaller than the predetermined value, is received, extra computation process regarding the complex shape of the structure is not required and a stress distribution can be obtained in shorter period of time.

According to the third, sixth and ninth aspect, it is possible to secure not only the continuity of stress value at the vertex of the divided region, in which displacements can be specified, but also the continuities of displacement and stress at borders of divided regions without using complicated computation process.

### BRIEF DESCRIPTION OF THE DRAWINGS

FIG. 1 is a block diagram showing a structure of a finite element analysis apparatus according to Embodiment 1 of the present invention;

FIG. 2 is a diagram showing a square region as an example of a finite element used in Embodiment 1:

FIG. 3 is a schematic view showing a process of dividing a cell of the square region in the first layer into cells in the second layer, third layer, . . . , and n-th layer (n is a natural number) based on a state determination by a CPU;

FIG. 4 is a flow chart showing a procedure of the CPU of the finite element analysis apparatus according to Embodiment 1 of the present invention;

FIG. 5 is a diagram showing a square region as an example of a finite element used in Embodiment 2;

FIG. 6 is a schematic view showing a method of correcting displacement at a border between two cells A and B which are composed of square regions;

FIG. 7 is a schematic view showing a condition of nodal force at nodes A1, B1, C1, D1 where divided four regions A, B, C, D contact with each other in the m-th layer (m is a natural number satisfying 0<m≦n);

FIG. 8 is a schematic view showing a method for computing a nodal force generated at a node in the (m−1)-th layer; and

FIG. 9 is a flow chart showing a processing procedure in a CPU of a finite element analysis apparatus according to Embodiment 2 of the present invention.

### BEST MODES FOR CARRYING OUT THE INVENTION

### Embodiment 1

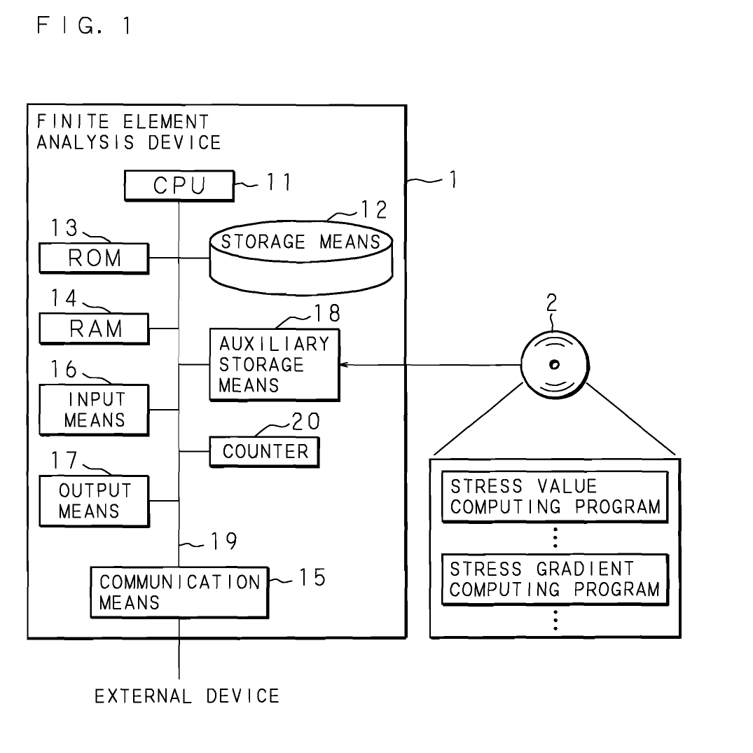

The present invention will be described in detail with reference to the drawings showing Embodiment 1 of the present invention. FIG. 1 is a block diagram showing a structure of a finite element analysis apparatus according to Embodiment 1 of the present invention. As shown in FIG. 1, the finite element analysis apparatus 1 includes at least a CPU (central processing unit) 11, storage means 12, a ROM 13, a RAM 14, communication means 15 for connecting to a communication line, input means 16 such as a mouse or a keyboard, output means 17 such as a display, auxiliary storage means 18, and a counter 20.

The CPU 11 is connected, via an internal bus 19, to each part of hardware of the finite element analysis apparatus 1. The CPU 11 controls each part of the hard ware and carries out various software functions according to a control program stored in the ROM 13 or a control program installed to the storage means 12 by using the auxiliary storage means 18, that is, a (portable) recording medium 2 such as a CD-ROM or DVD. Here, the storage means 12 is a fixed storage medium such as a hard disk and stores the control program and data needed for processes in advance.

The RAM 14 is composed of an SRAM, a flash storage or the like and stores temporary data generated when software is implemented. The communication means 15 is connected to the internal bus 19 to obtain data from the outside and to send and receive operation control data or the like of an external device.

The input means 16 is an input medium such as a keyboard or a mouse, which includes keys needed to operate the finite element analysis apparatus 1, such as alphabetical keys, numerical keys, and various function keys. The output means 17 is a display device such as a liquid crystal display device or CRT display to display an operational condition of the finite element analysis apparatus 1 or a screen for urging a user to input or image data showing analysis results graphically. Here, when the output means 17 is provided as a touch panel system, the output means 17 may be substitute for a part or all of the various function keys of the input means 16.

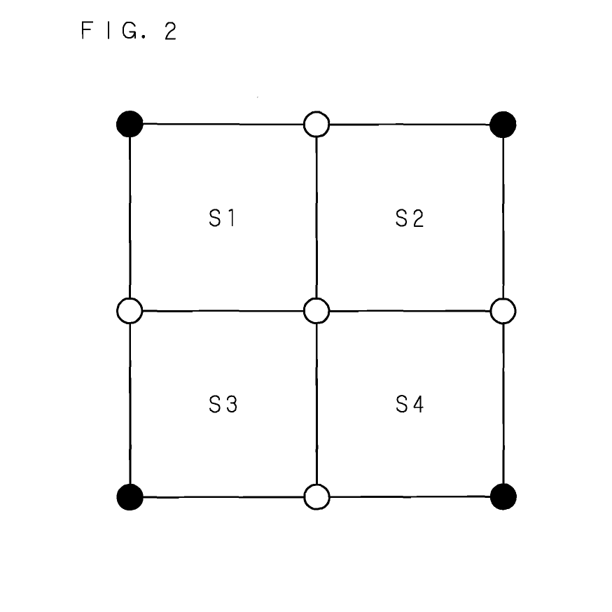

An operation for computing a stress distribution in the finite element analysis apparatus 1 will be described by taking a two-dimension problem as an example. FIG. 2 is a diagram showing a square region as an example of a finite element used in Embodiment 1. In FIG. 2, the square region is defined by a cell composed of nine nodes with four elements. Here, it is obvious that the definition of the square region should not be limited to this and the square region may be a cell composed of, for example, nine nodes with an element, or may be a solid cell when the subject is three-dimensional.

Generally, displacement value and stress value for each square region to which a predetermined external force is applied are computed by solving partial differential equation under an assumption that the displacements of the four nodes forming vertexes among the nine nodes are known and the displacements of other five nodes are unknown. In FIG. 2, the nodes whose displacements are known are represented by black circles and the nodes whose displacements are unknown are represented by white circles.

The structure to be analyzed is divided into cells of square region as shown in FIG. 2 and the CPU 11 of the finite element analysis apparatus 1 computes, for example, stress values S1, S2, S3, S4 for each of the four regions divided by the nodes. More specifically, the partial differential equation applied with a predetermined external force is converted to a simultaneous equation to compute an approximate solution of stress value for each of the four regions by a numerical analysis using finite elements.

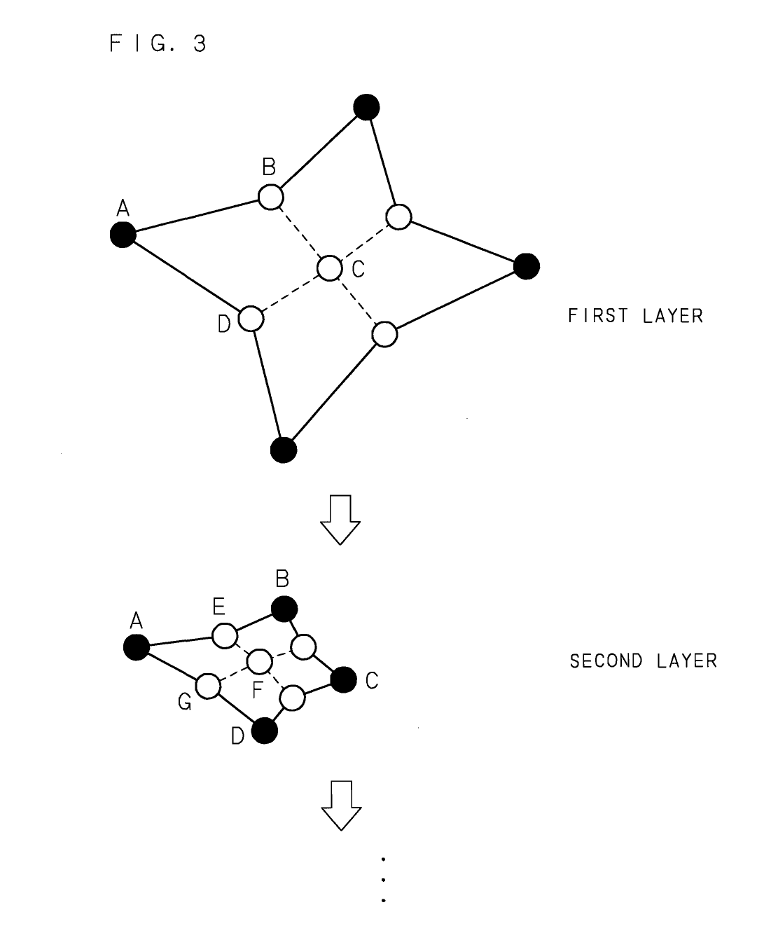

The CPU 11 of the finite element analysis apparatus 1 computes differences among the four computed stress values and determines whether or not the largest difference is smaller than a predetermined threshold value so as to determine whether or not the square region is needed to be divided into smaller regions. When the CPU 11 determines that the largest difference is greater than the threshold value, the cell composed of the square region is divided into cells composed of smaller square regions. FIG. 3 is a schematic view showing a process of dividing the cell of the square region in the first layer into cells in the second layer, third layer, . . . , and n-th layer (n is a natural number) based on the state determination by the CPU 11.

When it is determined that, regarding the cell of square region in the first layer, the largest difference among the stress values of the four regions is greater than the predetermined threshold value, the square region is divided into four squares to generate cells of square regions in the second layer. FIG. 3 shows an example of a cell composed of a square region in the second layer, which obtained by dividing into four regions.

In the cell of square regions in the first layer, since the node A forms a vertex, its displacement is known (black circle). On the other hand, the displacements of the nodes B, C and D are unknown (white circle). However, when the cell is divided to a cell formed with a square region in the second layer, the nodes A, B, C and D form vertexes of a new square region so that the displacement of those nodes become to be known (black circle). On the other hand, the displacements of the nodes E, F, G are unknown (white circle).

Then, every time when a square region in the (n−1)-th layer is divided into four regions to generate cells composed of square regions in the n-th layer, the nodes of known displacement is switched and stress value is computed. When the stress gradient in the cell is equal to or smaller than the predetermined value, dividing process completes and definitive displacement and stress of the analyzed structure are obtained. According to a conventional structural analysis program, mesh division for a complex part of structure is made finer and mesh division in a simple part of the structure is made larger. Since the analysis is implemented according to empirical rules, accident errors have been found in the analysis results due to the skill level of engineers who perform mesh dividing. On the other hand, according to the finite element analysis apparatus 1 of Embodiment 1, since the state of mesh division can be specified according to the largest difference computed based on analyzed stress values, that is, the stress gradient in the finite element, without relying on engineers' skill, extra computation process can be omitted while maintaining the accuracy of the analysis.

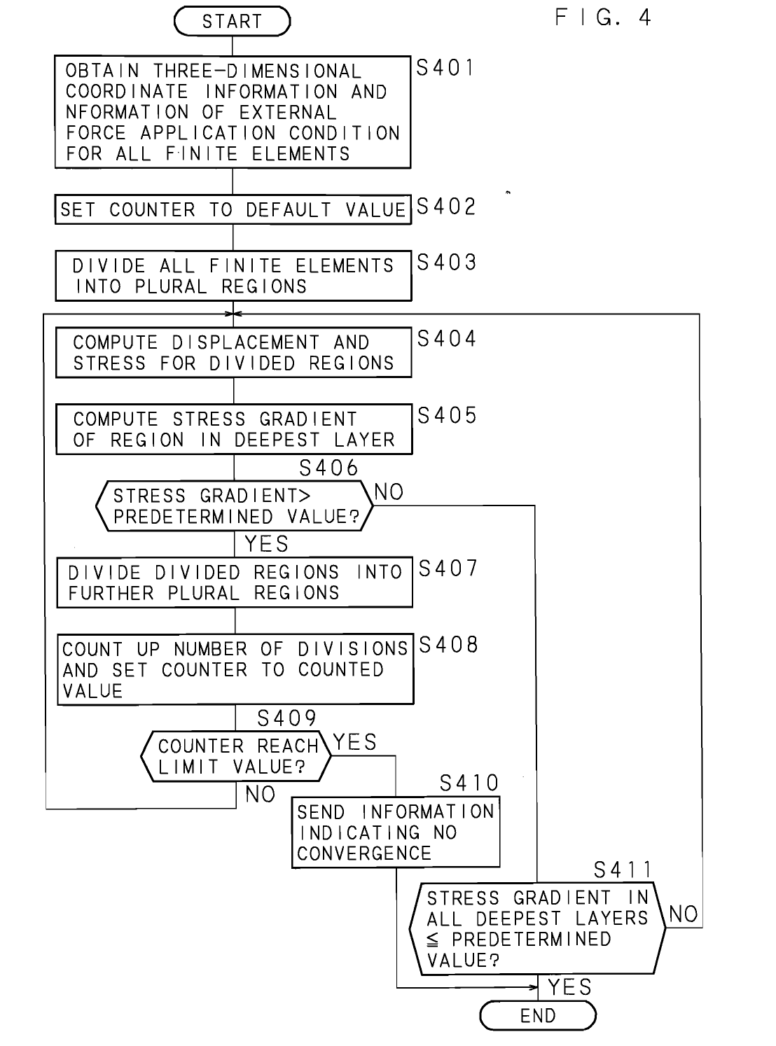

FIG. 4 is a flow chart showing a procedure of the CPU 11 of the finite element analysis apparatus 1 according to Embodiment 1 of the present invention. The CPU 11 of the finite element analysis apparatus 1 obtains three-dimensional coordinate information and information of external force application condition for all finite elements of the structure to be analyzed (step S401). The CPU 11 sets a counter 20 showing the number of divisions to a default value (step S402) and divides all finite elements into a plurality of regions (step S403).

The CPU 11 computes displacement and stress for the divided regions (step S404) and computes the stress gradient of a region in the deepest layer (step S405). The CPU 11 determines whether or not the computed stress gradient is greater than a predetermined value such as a limit value of calculation errors (step S406). When the CPU 11 determines that the computed stress gradient is greater than the predetermined value (step S406: YES), the CPU 11 divides the divided regions into a further plurality of regions, for example, into four regions when the regions are square regions (step S407). Then, the CPU 11 counts up the number of divisions and sets the counter 20 to the counted value (step S408) and determines whether or not the counted value of the counter 20 reaches the predetermined limit value (step S409).

When the CPU 11 determines that the counted value of the counter 20 reaches the predetermined limit value (step S409: YES), the CPU 11 causes the output means 17 to output information, which indicates that the largest value in difference of the stress values is greater than the predetermined value, for example, message information or color presentation information for graphic display (step S410), the CPU 11 completes the procedure.

When the CPU 11 determines that the counted value of the counter 20 does not reach the predetermined limit value, (step S409: NO), the procedure goes back to step S404 to repeat the above described procedures.

When the CPU 11 determines the computed stress gradient is equal to or smaller than the predetermined value (step S406: NO), the CPU 11 determines, for all of the divided regions, whether or not the stress gradient in the currently deepest layer region is equal to or smaller than the predetermined value (step S411). When the CPU 11 determines that stress gradient in one of the divided regions is greater than the predetermined value (step S411: NO), the procedure gores back to step S404 to repeat the above described procedures. When the CPU 11 determines, for all of the divided regions, that the stress gradients in the currently deepest layer are equal to or smaller than the predetermined value (step S411: YES), the CPU 11 completes the procedure.

As described above, according to Embodiment 1, each finite element obtained by mesh division of the region occupied by the structure is divided in to a plurality of regions and the largest value of differences among stress values in the divided regions, that is, a stress gradient, is computed. When the computed stress gradient is greater than a predetermined value, the region is divided into a further plurality of smaller regions and the stress gradient for each of the divided regions is computed again. This procedure is repeated for layering. When the stress gradient becomes equal to or smaller than the predetermined value before the number of layering reaches a predetermined limit value, an approximate stress distribution can be obtained by solving low-dimensional simultaneous equations for each layer even if the high-dimensional simultaneous equations are needed to be solved as a whole. Accordingly, since the computation time is simply proportional to a total number of the divided regions included in all the layers, the computation time should not increase exponentially as seen in conventional calculation method.

Therefore, even when the shape of the structure becomes complex and the order of simultaneous equations converted from the partial differential equation becomes a large number, the computation time merely increases in proportion to the total number of the regions obtained by dividing the finite elements into layers of finer mesh. Thus, a stress distribution can be obtained in a short period of time without reducing the accuracy of the calculation.

Further, when the stress gradient does not get equal to or smaller than the predetermined value even if the number of the layering reaches the predetermined limit value, that state can be easily reported to a user by using a display device so that the user can find the state, for example, an unconformity in the mesh or an occurrence of crack.

Here, the limit value of the number of layering may be determined and stored in the storage means 12 and RAM 14 in advance, or may be input by the use from the input means 16 (receiving unit). Further, an input from an external device may be received via the communication means 15 (receiving unit).

As described above, when the limit value of the number of layering is not fixed and the user sets the limit value according to the complexity of the shape of the structure to be analyzed so as to prevent the excess in computation load, stress distribution can be obtained in a short period of time without implementing extra calculation processes for divided regions that is not needed to be computed.

### Embodiment 2

The present invention will be described in detail with reference to drawings showing Embodiment 2. The structure of a finite element analysis apparatus according to Embodiment 2 is the same as that of Embodiment 1, so the same numerals are assigned to the same parts and those descriptions will be omitted here. Embodiment 2 is characterized in that the displacement values and the stress values computed for each layer are corrected so as to maintain continuity of the displacements and stress values at the borders between the divided regions of finite element.

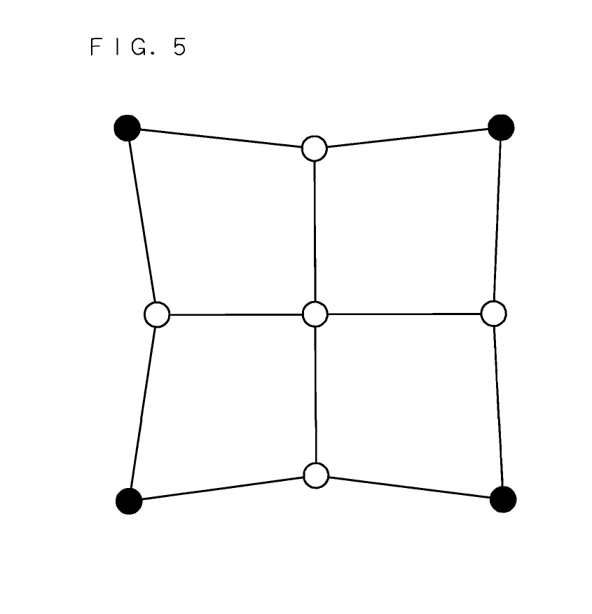

FIG. 5 is a diagram showing a square region as an example of a finite element used in Embodiment 2. In FIG. 5, the square region is defined as a cell composed of nine nodes and four elements; however, the definition of the square region should not limited to this and the region may be, for example, a cell composed of nine nodes and an element, or a solid cell.

Generally, displacement value and stress value under a predetermined external force for each of the square regions are computed by solving partial differential equation under an assumption that the displacements of the four nodes forming vertexes among the nine nodes are known and the displacements of other five nodes are unknown. In FIG. 5, the nodes whose displacements are known are represented by black circles and the nodes whose displacements are unknown are represented by white circles.

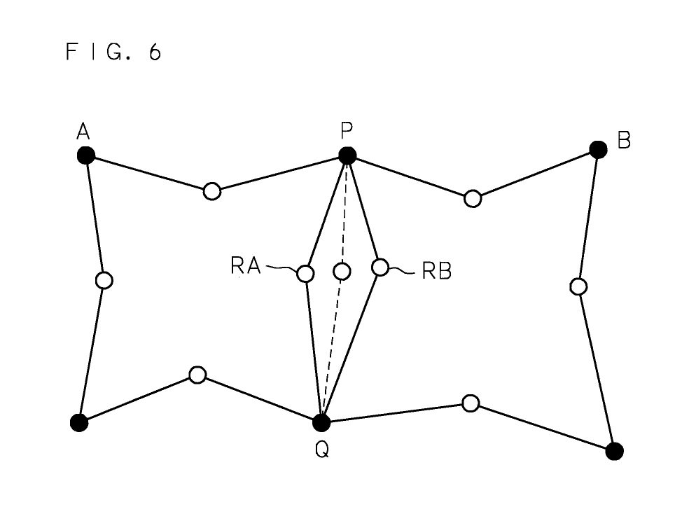

FIG. 6 is a schematic view showing a method of correcting displacement at a border between cells A and B which are composed of square region shown in FIG. 5. In FIG. 6, on an orthogonal plane coordinates (x, y), displacements of nodes P, Q of the two cells A, B correspond to each other. In order to maintain the continuity of the displacements (uA, vA), (uB, vB) of the nodes RA, RB between the nodes P, Q, a proportional distribution based on a stiffness ratio is carried out in use of stiffness (KuA, KvA), (KuB, KvB) at the nodes RA, RB of the cells A, B. In other words, a corrected common displacement (uAB, vAB) of the nodes RA, RB can be obtained by Equation 1.

uAB=(uA·KuA+uB·KuB)/(KuA+KuB)

vAB=(vA·KvA+vB·KvB)/(KvA+KvB) (Equation 1)

As a matter of course, it is not limited to a correction for the proportional distribution based on stiffness ratio. For example, in case of a deformation due to bending load, it is preferable to correct based on proportional distribution based on bending stiffness ratio.

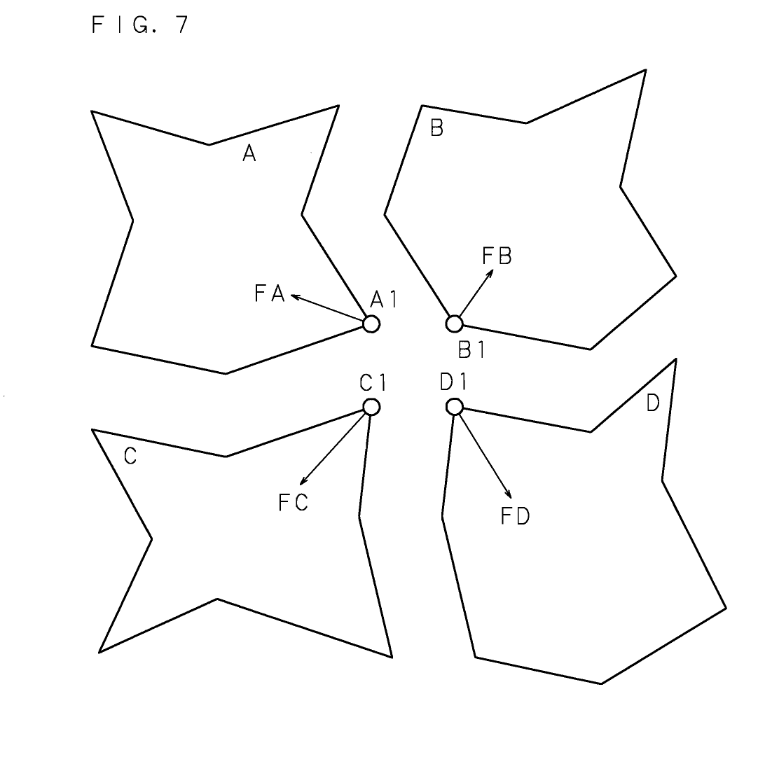

It is not certain that the nodal force (stress) against the common displacement (uAB, vAB) computed by Equation 1 always satisfy equilibrium condition. Accordingly, the equilibrium condition is confirmed when the vectorial sum of nodal force is 0 (zero) or an absolute value is equal to or smaller than a predetermined value for the deepest layer among the divided layers, that is, a layer having the largest value of the counter 20. FIG. 7 is a schematic view showing a condition of nodal forces at nodes A1, B1, C1, D1 where the divided four regions A, B, C, D contact with each other in the m-th layer (m is a natural number satisfying 0<m≦n).

In FIG. 7, nodal force vectors of four nodes A1, B1, C1, D1 are represented as FA, FB, FC, FD respectively and it is determined whether or not equilibrium condition is satisfied according to whether or not the vectorial sum becomes (0, 0) on a plane coordinates (x, y). It is noted that it may be determined according to whether or not the absolute value of the vectorial sum is equal to or smaller than a predetermined value.

For example, when the m-th layer is the deepest layer, stress and vectorial sum of nodal forces in the m-th layer are computed to determine whether or not the equilibrium condition is satisfied for all the cells in the deepest layer. When it is determined that the equilibrium condition is not satisfied for all the cells in the deepest layer, the procedures goes on to the following procedures to correct the division location so as to satisfy the equilibrium condition.

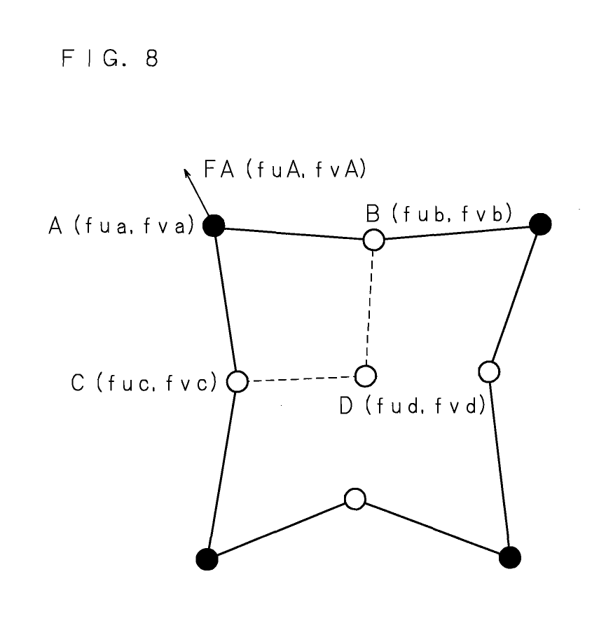

When it is determined that the equilibrium condition is not satisfied in the m-th layer, which is the deepest layer, since the nodal forces of the nodes in the m-th layer are computed as vector values, nodal forces generated at the nodes in the original layer, that is, the (m−1)-th layer as an upper layer of the m-th layer, which is divided to form the m-th layer, based on the computed nodal force. FIG. 8 is a schematic view showing a method for calculating the nodal forces generated at the nodes in the (m−1)-th layer.

When the nodal forces of the nodes A, B, C, D of the square region in the (m−1)-th layer are represented as (fua, fva), (fub, fvb), (fuc, fvc) and (fud, fvd), the nodal force (fuA, fvA) in u direction and v direction at the node A in the (m−1)-th layer may be obtained as a equivalent nodal force with Equation 2.

fuA=fua+(fub+fuc)/2+fud/4

fvA=fva+(fvb+fvc)/2+fvd/4 (Equation 2)

As a matter of course, the method for calculating (fuA, fvA) should not limited to this and a proper division may be determined in advance based on, for example, stiffness distribution to compute based on the predetermined division.

As described above, nodal forces for each node are computed with reference to the square regions in the first layer, that is, the finite element obtained by mesh division of the structure region, in order to compute a vectorial sum based on the re-computed nodal force. Then, definitive displacement and stress can be obtained by repeatedly calculating cell displacements for each layer (displacement correction amount) based on the computed vectorial sum, until all equilibrium conditions in the deepest layer are satisfied.

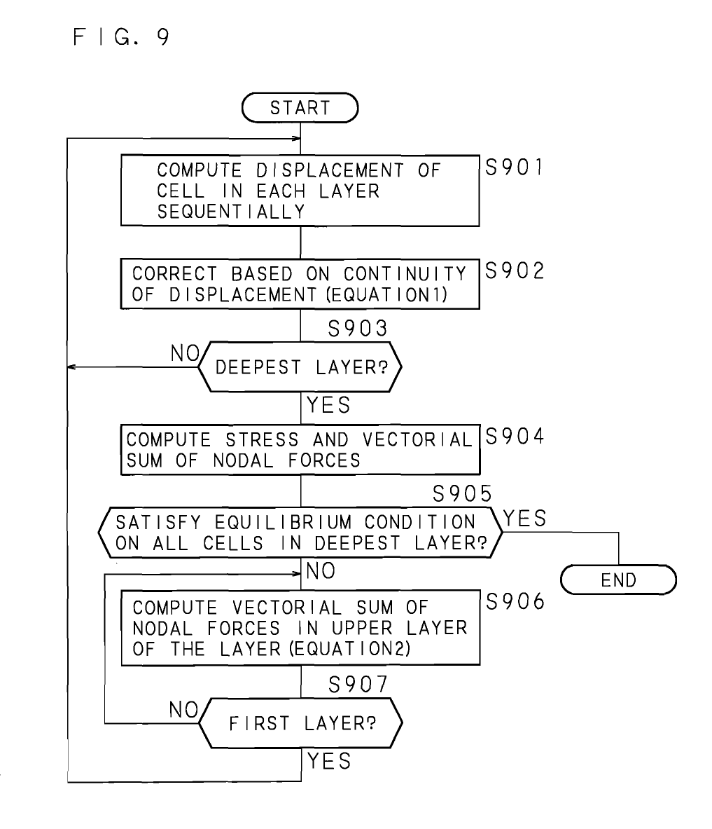

FIG. 9 is a flow chart showing a processing procedure in the CPU 11 of the finite element analysis apparatus 1 according to Embodiment 2 of the present invention. The CPU 11 of the finite element analysis apparatus 1 sequentially computes displacements at borders of cells composed of, for example, square regions, sequentially starting with in the first layer (step S901) and computes the amount of displacement correction according to equation 1 (step S902).

The CPU 11 determines whether or not the correction process on cell borders is completed up to the deepest layer (the m-th layer) among the divided layers (step S903). When the CPU 11 determines the correction process on cell borders are not completed up to the deepest layer (the m-th layer) (step S903: NO), the procedure goes back to step S901 to repeat the above described process. When the CPU 11 determines that the correction process on the cell borders is completed up to the deepest layer (the m-th layer) (step S903: YES), the CPU 11 computes stress of the cell and vectorial sum of nodal forces (stress) generated at the nodes in the deepest layer (step S904).

The CPU 11 determines, in all of the deepest layers, whether or not the computed vectorial sum satisfies a predetermined equilibrium condition, for example, whether or not the absolute value of the computed vectorial sum is smaller than a predetermined threshold value (step S905). When the CPU 11 determines that, in one of the deepest layers, the computed vectorial sum does not satisfy the predetermined equilibrium condition (step S905: NO), the CPU 11 sequentially computes again the vectorial sum of nodal force (stress) generated at nodes of the upper layer ((m−1)-th layer, (m−2)-th layer, . . . ) of the layer (m-th layer), which does not satisfy the equilibrium condition, according to equation 2 (step S906).

The CPU 11 determines whether or not the process for calculating vectorial sum of the nodal forces (stress) reaches the first layer (step S907). When the CPU 11 determines that the process does not reaches the first layer (step S907: NO), the CPU 11 goes back to step S906 to repeat calculation of the vectorial sum of the nodal force (stress) generated at nodes in the upper layers until reaching the first layer.

When the CPU 11 determines that the process reaches the first layer (step S907: YES), the CPU 11 goes back to step S901 to sequentially compute displacements of cell borders in each layer to determine whether the equilibrium condition is satisfied again.

The CPU 11 repeats computing vectorial sums of nodal forces (stress) of all the cells in the deepest layer. When the CPU 11 determines that the computed vectorial sums satisfies the predetermined equilibrium condition in all of the deepest layers (step S905: YES), the CPU 11 determines that the continuities of the displacements and the nodal force (stress) are secured so that the process is completed.

As described above, according to Embodiment 2, even when each of the finite elements obtained by mesh division of the region occupied by the structure is divided into a plurality of regions, it is possible not only to secure continuity of stress value at the vertex of the divided region, in which displacements can be specified, but also to secure continuities of displacement and stress at borders of divided regions without complicated calculation process. Therefore, it is possible to realize a high-speed calculating device capable of completing calculation process in high-speed without reducing the accuracy of the computed stress.

1-9. (canceled)

10. A finite element analysis method for implementing analysis of stress under a predetermined external force for each of a plurality of finite elements obtained by dividing a region occupied by a structure, the method comprising the steps of:
dividing each of the finite elements into a plurality of regions, setting a counter showing the number of divisions to a default value, calculating a displacement value and a stress value for each of the divided regions, calculating a largest value of stress value differences among the regions, and determining whether or not the calculated largest value is greater than a predetermined value;
when it is determined that the largest value is greater than the predetermined value, dividing the plurality of regions into a further plurality of regions, setting the counter to a value obtained by counting up the number of divisions, and calculating a largest value of stress value differences among the divided regions by repeatedly calculating for each of the regions;
determining whether or not the value of the counter reaches a predetermined limit value;
when the value of the counter does not reach the limit value, dividing the further divided regions into a further plurality of regions, setting the counter to a value obtained by counting up the number of divisions, and calculating a largest value of stress value differences among the divided regions by repeatedly calculating for each of the regions; and
when it is determined that the value of the counter reaches the limit value, outputting information indicating that the largest value of the stress value differences is greater than the predetermine value.

11. The finite element analysis method according to claim 10, further comprising the step of receiving the limit value.

12. The finite element analysis method according to claim 10, further comprising the steps of:
correcting the displacement value and the stress value so that displacement and stress continuously change at borders of the plurality of divided regions; and
calculating a largest value of stress value differences among the regions based on the corrected stress value.

13. A finite element analysis apparatus for implementing analysis of stress under a predetermined external force for each of a plurality of finite elements obtained by dividing a region occupied by a structure, the apparatus comprising:
a counter for showing the number of divisions;
a processor capable of:
dividing each of the finite elements into a plurality of regions;
setting the counter to a default value;
calculating a displacement value and a stress value for each of the divided regions;
calculating a largest value of stress value differences among the regions;
determining whether or not the calculated largest value is greater than a predetermined value;
dividing the plurality of regions into a further plurality of regions when it is determined that the largest value is greater than the predetermined value;
setting the counter to a value obtained by counting up the number of divisions;
calculating a largest value of stress value differences among the divided regions by repeatedly calculating for the each of the regions;
determining whether or not the value of the counter reaches a predetermined limit value;
dividing the further divided regions into a further plurality of regions when it is determined that the value of the counter does not reach the limit value; and
calculating a largest value of stress value differences among the divided regions by repeatedly calculating for each of the regions; and
an output unit for outputting information indicating that the largest value of the stress value differences is greater than the predetermined value when it is determined that the value of the counter reaches the limit value.

14. The finite element analysis apparatus according to claim 13, further comprising a receiving unit for receiving the limit value.

15. The finite element analysis apparatus according to claim 13, wherein said processor is further capable of:
correcting the displacement value and the stress value so that displacement and stress continuously change at borders of the plurality of divided regions; and
calculating a largest value of stress value differences among the regions based on the corrected stress value.

16. A finite element analysis apparatus for implementing analysis of stress under a predetermined external force for each of a plurality of finite elements obtained by dividing a region occupied by a structure, the apparatus comprising:
means for dividing each of the finite elements into a plurality of regions;
a counter for showing the number of divisions;
means for setting the counter to a default value;
means for calculating a displacement value and a stress value for each of the divided regions;
means for calculating a largest value of stress value differences among the regions;
means for determining whether or not the calculated largest value is greater than a predetermined value;
means for dividing the plurality of regions into a further plurality of regions when it is determined that the largest value is greater than the predetermined value;
means for setting the counter to a value obtained by counting up the number of divisions;
means for calculating a largest value of stress value differences among the divided regions by repeatedly calculating for the each of the regions;
means for determining whether or not the value of the counter reaches a predetermined limit value;
means for dividing into a still further plurality of regions when it is determined that the value of the counter does not reach the limit value;
means for calculating a largest value of stress value differences among the divided regions by repeatedly calculating for each of the regions; and
means for outputting information indicating that the largest value of the stress value difference is greater than the predetermined value when it is determined that the value of the counter reaches the limit value.

17. The finite element analysis apparatus according to claim 16, further comprising means for receiving the limit value.

18. The finite element analysis apparatus according to claim 16, further comprising:
means for correcting the displacement value and the stress value so that displacement and stress continuously change at borders of the plurality of divided regions; and
means for calculating a largest value of stress value differences among the regions based on the corrected stress value.

19. A recording medium on which a computer program is recorded, said computer program capable of being executed with a computer for implementing analysis of stress under a predetermined external force for each of a plurality of finite elements obtained by dividing a region occupied by a structure, the program for causing the computer to execute:
a step of dividing each of the finite elements into a plurality of regions;
a step of setting a counter showing the number of divisions to a default value;
a step of calculating a displacement value and a stress value for each of the divided regions;
a step of calculating a largest value of stress value differences among the regions;
a step of determining whether or not the calculated largest value is greater than a predetermined value;
a step of dividing the plurality of regions into a further plurality of regions when it is determined that the largest value is greater than the predetermined value;
a step of setting the counter to a value obtained by counting up the number of divisions;
a step of calculating a largest value of stress value differences among the divided regions by repeatedly calculating for each of the regions;
a step of determining whether or not the value of the counter reaches a predetermined limit value;
a step of dividing the further divided regions into a further plurality of regions when it is determined that the value of the counter does not reach the limit value;
a step of setting the counter to a value obtained by counting up the number of divisions;
a step of calculating a largest value of stress value differences among the divided regions by repeatedly calculating for each of the regions; and
a step of outputting information indicating that the largest value of the stress value differences is greater than the predetermined value when it is determined that the value of the counter reaches the limit value.

20. The recording medium according to claim 19, wherein the program causes the computer to further execute a step of receiving the limit value.

21. The recording medium according to claim 19, wherein the program causes the computer to further execute:
a step of correcting the displacement value and the stress value so that displacement and stress continuously change at borders of the plurality of divided regions; and
a step of calculating a largest value of stress value differences among the regions based on the corrected stress value.
